(19) United States
(12) Patent Application Publication
(10) Pub. No.: US 2024/0391549 A1
(43) Pub. Date: Nov. 28, 2024

(54) COLLAR ATTACHMENT FOR DROPPER SEATPOST ACCESSORIES

(71) Applicant: Tailfin Limited, Bristol (GB)

(72) Inventors: Nicholas BROADBENT, Long Ashton (GB); Robert PHILLIPS, Bristol (GB)

(21) Appl. No.: 18/673,710

(22) Filed: May 24, 2024

(30) Foreign Application Priority Data
May 25, 2023 (GB) 2307884.3

(51) Int. Cl. B62J 9/27; B62J 1/08; B62J 9/26

(52) U.S. Cl. CPC B62J 9/27; B62J 9/26; B62J 1/08; B62J 2001/085

(57) ABSTRACT

A collar attachment for use with dropper seatposts on bicycles for securely attaching saddlebags during touring or bikepacking. The collar attachment includes front and rear lower lips for supporting respectively a strap and a mounting attachment of the bag. The collar attachment has a first internal bore, possibly provided with a resilient, tacky liner, which is a close fit around the seatpost, and a second internal bore, of larger diameter than the bore, which allows the collar to drop over a dropper post collar, minimising any loss of dropper travel. The invention may include a resilient and tacky lining such as thermoplastic polyurethane (TPU) to accommodate a wide range of diameter dimensions and tolerances.

### FIELD OF THE INVENTION

This invention relates to a collar attachment for dropper seatpost accessories, and in particular for accessories in the form of saddlebags.

### BACKGROUND

Bikepacking is a popular leisure pursuit that involves multi-day touring on a bicycle. Essential gear for this activity is carried on the bicycle itself or by the rider. Saddlebags are an important type of pack used in bikepacking, typically attached between the underside of the saddle and behind the seatpost. However, complications arise when using dropper seatposts, a type of pneumatic seatpost adjustable in height while riding. Conventional saddlebag attachment methods can interfere with the function of dropper seatposts and potentially cause damage. Existing solutions, like the use of a simple collar attached to the upper post, often reduce the travel of the dropper post, thus diminishing the bike's rideability.

### SUMMARY

According to the present invention there is provided a collar attachment for supporting an accessory on a bicycle seatpost, the collar attachment having a first internal bore for receiving the seatpost, and a second internal bore, of larger diameter than the first internal bore, situated below the first internal bore with respect to the orientation of the seatpost in normal use, the collar attachment being provided with a front strap-retaining lip situated at the lower region of the collar attachment and with a rear supporting lip situated at the lower region of the collar attachment opposite the front strap-retaining lip, the rear supporting lip being disposed at a lower level than the front strap-retaining lip.

The first and second internal bores may be coaxial. The collar attachment may comprise two parts which are secured together by fasteners. The two parts may be interconnected by a living hinge.

A liner of resilient material, for example of thermoplastic polyurethane, may be provided on the first internal bore.

The collar attachment may be fitted to a bicycle seatpost, the first internal bore being a close fit on the seatpost.

Another aspect of the present invention provides a bicycle on which a saddlebag is mounted, the saddlebag being connected to the seatpost by the collar attachment.

The seatpost may be a dropper seatpost, in which case the seatpost may be axially displaceable through a dropper seatpost collar fitted to the top of a seat tube of the bicycle, the diameter of the second internal bore being sufficiently large to accommodate the dropper seatpost collar. Thus, when the seatpost is in a lowered condition, the second internal bore accommodates the dropper seatpost collar through which the seatpost extends.

The present invention provides an innovative solution in the form of a collar attachment for securely fastening saddlebags to dropper seatposts, minimising travel loss and preventing damage. The collar is designed with a counterbore from the underside, allowing it to drop over the dropper post collar, and likely only reducing the dropper travel by 10-20 mm. It also includes front and rear lower lips to prevent the saddlebag strap from slipping off. The collar may be composed of two pieces of rigid materials, such as plastic or metal, held together by screws. Alternatively, a single piece of plastic with a living hinge may be used. A resilient and tacky material like TPU can be used as a lining inside the collar to accommodate different diameter dimensions and tolerances.

### BRIEF DESCRIPTION OF THE DRAWING FIGURES

For a better understanding of the present invention, and to show more clearly how it may be carried into effect, reference will now be made, by way of example, to the accompanying drawings, in which:

FIG. 1 shows a bicycle having a dropper seatpost provided with a collar attachment;

FIG. 2 is an enlarged view showing the collar attachment;

FIG. 3 is a side view corresponding to FIG. 2;

FIG. 4 is a sectional view showing the dropper seatpost in a lowered condition;

FIG. 5 corresponds to FIG. 4 but shows the dropper seatpost in a raised condition; and

FIG. 6 corresponds to FIG. 3 but shows an attached saddlebag.

### DETAILED DESCRIPTION

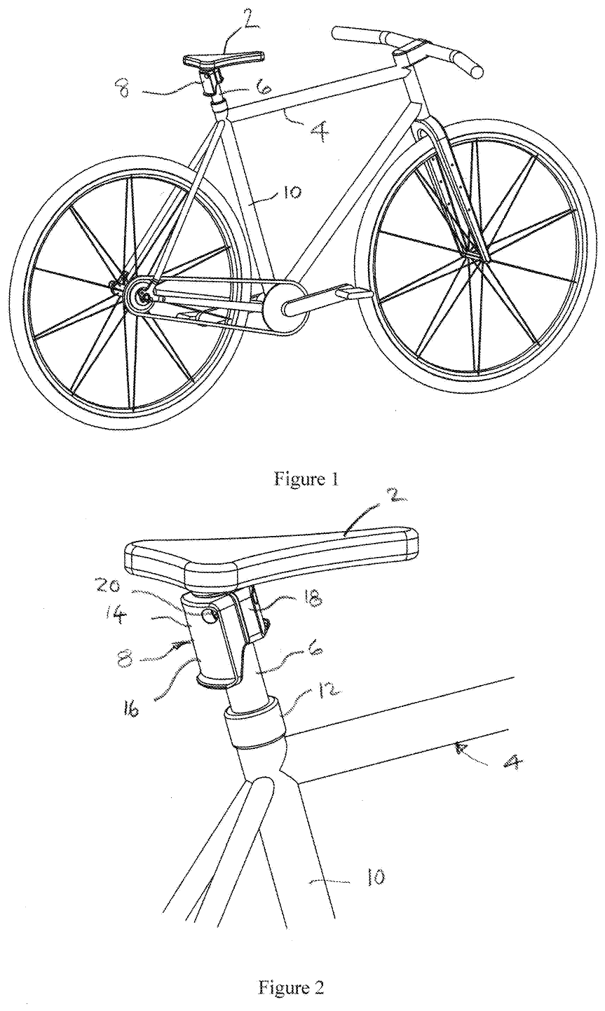

The bicycle shown in FIG. 1 is of generally conventional construction and includes a saddle 2 supported on the frame 4 of the bicycle by a dropper seatpost 6. A collar attachment 8 is fitted to the seatpost 6.

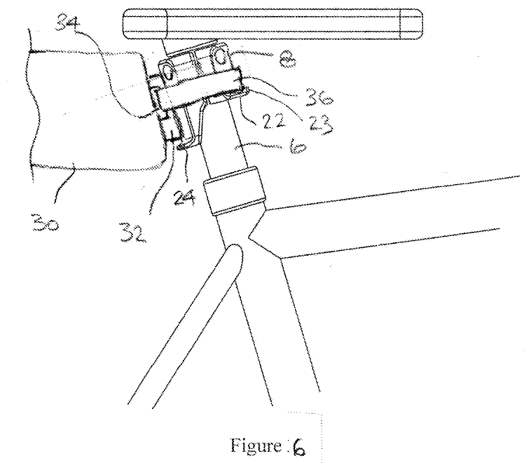

The dropper seatpost 6 is of generally known form and is provided with a mechanism, for example a hydraulic mechanism, for enabling the seatpost 6 to be extended from, or retracted into, a seat tube 10 of the bicycle frame 4. This mechanism enables the saddle 2 to be raised and lowered while riding, as shown in FIGS. 4 and 5. The mechanism includes a dropper seatpost collar 12 which is situated at the top of the seat tube 10, and through which the seatpost 6 passes. There is a seal between the seatpost 6 and the collar 12.

If an accessory, such as a saddlebag, is attached directly to the seatpost 6 by means of a conventional connector, the connector occupies a portion of the seatpost 6 which would enter the seat tube 10 when fully retracted in the absence of the connector. Consequently the connector obstructs the travel of the seatpost 6 and prevents the saddle 2 from being fully lowered.

The collar attachment 8 shown in the drawings comprises a split body 14. The body 14 may be assembled from two separate parts which are interconnected around the seatpost 6 by any suitable means, but in the embodiment shown in the drawings, the body 14 is made from a substantially rigid plastics material and comprises two parts 16, 18 which are formed integrally with each other by moulding, but are interconnected by a living hinge. The two parts 16, 18 can thus be opened out to fit around the seatpost 6, and can then be clamped together by means of a screw 20 to secure the collar attachment 8 securely to the seatpost 6. A lining of resilient, tacky material may be provided between the seatpost 6 and the internal surfaces of the collar attachment 8, for example as a liner attached to the collar attachment 8. Such a liner avoids damage to the surface of the seatpost 6, and also enhances friction between the seatpost 6 and the collar attachment 8 to avoid the collar attachment 8 slipping down, or around, the seatpost 6. The liner also serves to accommodate a wide range of diameter dimensions and tolerances.

The collar attachment 8 is provided with a pair of lips 22, 24 which project radially outwardly of the collar attachment 8. The lip 22 projects forwardly, with respect to the direction of travel of the bicycle, while the lip 24 projects to the rear, and is situated further down the seatpost 6 than the front lip 22. The lip 22 has a slight upturned edge 23.

The interior of the collar attachment 8, as seen in FIGS. 4 and 5, has, at its upper region, an internal bore 26 which (allowing for the interposition of a liner as mentioned above) is a close fit on the seatpost 6. At the lower region of the collar attachment 8, there is a wider bore 28 which is of a sufficient diameter to fit over the collar 12 at the top of the seat tube 10. It will thus be appreciated that, when the seat 2 is lowered, as shown in FIG. 4, the collar attachment 8 is able to fit over the collar 12, so allowing the seatpost 6 to retract almost fully into the seat tube 10. Note that, for explanatory purposes, the saddle 2, seatpost 6 and collar 12 are shown as a single component, whereas, in fact, the seatpost 6 is axially displaceable through the collar 12, which is in the form of a ring fitted to the top of the seat tube 10.

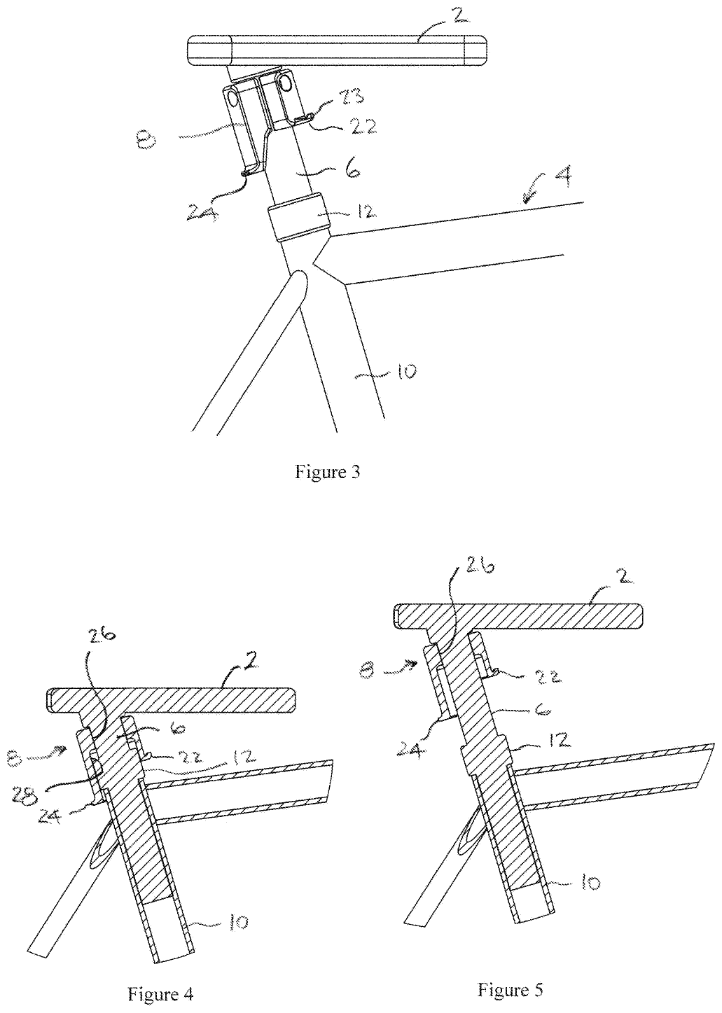

FIG. 6 corresponds to FIG. 3 but shows a saddlebag 30 fitted to the seatpost 6 by means of the collar attachment 8. The saddlebag 30 is provided with a mounting attachment 32 which is secured to a substantially rigid internal structure (not shown) of the saddlebag 30. The mounting attachment 32 is provided with a slot 34 through which extends a strap 36 which may be of any suitable form but is preferably a highly stretchable resilient strap made from a suitable plastics material such as thermoplastic polyurethane (TPU). The strap 36 is wrapped around the collar attachment 8 and secured under tension to hold the mounting attachment 32 firmly against the collar attachment 8. The mounting attachment 32 and strap 36 may, for example, be of the form disclosed in our co-pending patent application GB2302337.7 (published as GB2617256A. In addition to attachment to the seatpost 6, the saddlebag 30 may also be secured to the saddle 2 by means of one or more straps or other attachment devices (not shown).

As can be seen from FIG. 6, the strap 36 rests on the front lip 22 and is retained by the upturned edge 23. The lip 22 thus prevents the strap from migrating downwardly off the collar attachment 8 under jolting and other inertial forces which occur when the bicycle is ridden over rough ground. Similarly, the rear lip 24 arrests any downward migration of the saddlebag 30, by obstructing the movement of the mounting attachment 32.

In summary, the proposed collar attachment for saddlebags as described above is designed specifically for bicycles with dropper seatposts. The collar attachment features a unique counterbore design from the underside, allowing it to drop over the dropper post collar, minimising any loss of dropper travel to only about 10-20 mm. This design is a significant improvement over existing solutions that can reduce dropper travel by up to 35 mm.

The collar attachment also includes front and rear lower lips. These lips serve to secure the saddlebag strap, preventing it from slipping off during use. This added security is critical during the rigorous movement typically experienced during bikepacking or touring.

The collar attachment can be constructed from two pieces of a rigid material like plastic or metal, such as nylon or aluminium. These pieces are held together using screws, either two or four in number. An alternative design approach could involve a single piece of plastic with a living hinge, reducing part count and potentially manufacturing complexity.

A final noteworthy feature of the invention is the optional lining on the inside of the collar, made from a resilient and tacky material such as TPU. This lining helps the collar accommodate a larger range of diameter dimensions and tolerances, enhancing its compatibility with various dropper seatpost designs.

For the avoidance of doubt, the present application extends to the subject-matter described in the following numbered Statements:

Statement 1. A collar attachment for supporting an accessory on a bicycle seatpost, the collar attachment a first internal bore for receiving the seatpost, and a second internal bore, of larger diameter than the first internal bore, situated below the first internal bore with respect to the orientation of the seatpost in normal use.

Statement 2. A collar attachment as in Statement 1, in which the first and second internal bores are coaxial.

Statement 3. A collar attachment as in Statement 1 or 2, in which a front strap-retaining lip is provided at the lower region of the collar attachment.

Statement 4. A collar attachment as in any one of the preceding Statements, in which a rear supporting lip is provided at the lower region of the collar attachment.

Statement 5. A collar attachment as in Statement 4 when a pendant to Statement 3, in which the rear supporting lip is situated opposite the front strap-retaining lip and is disposed at a lower level than the front strap-retaining lip.

Statement 6. A collar attachment as in any one of the preceding Statements, which comprises two parts are secured together by fasteners.

Statement 7. A collar attachment as in any one of Statements 1 to 5, which comprises two parts interconnected by a living hinge.

Statement 8. A collar attachment as in any one of the preceding Statements, in which a liner of resilient material is provided on the first internal bore.

Statement 9. A collar attachment as in Statement 8, in which the liner comprises thermoplastic polyurethane.

Statement 10. A collar attachment in accordance with any one of the preceding Statements which is fitted to a bicycle seatpost, the first internal bore being a close fit on the seatpost.

Statement 11. A bicycle provided with a collar attachment in accordance with Statement 10, in which a saddlebag is mounted on the bicycle, the saddlebag being connected to the seatpost by the collar attachment.

Statement 12. A bicycle as in Statement 11, in which the seatpost is a dropper seatpost.

Statement 13. A bicycle as in Statement 12, in which the seatpost is in a lowered condition, and in which the second internal bore accommodates a dropper seatpost collar through which the seatpost extends.

1. A collar attachment for supporting an accessory on a bicycle seatpost, the collar attachment having a first internal bore for receiving the seatpost, and a second internal bore, of larger diameter than the first internal bore, situated below the first internal bore with respect to the orientation of the seatpost in normal use, the collar attachment being provided with a front strap-retaining lip situated at the lower region of the collar attachment and with a rear supporting lip situated at the lower region of the collar attachment opposite the front strap-retaining lip, the rear supporting lip being disposed at a lower level than the front strap-retaining lip.

2. A collar attachment as claimed in claim 1, in which the first and second internal bores are coaxial.

3. A collar attachment as claimed in claim 1, which comprises two parts which are secured together by fasteners.

4. A collar attachment as claimed in claim 1, which comprises two parts interconnected by a living hinge.

5. A collar attachment as claimed in claim 1, in which a liner of resilient material is provided on the first internal bore.

6. A collar attachment as claimed in claim 5, in which the liner comprises thermoplastic polyurethane.

7. A collar attachment in accordance with claim 1 which is fitted to a bicycle seatpost, the first internal bore being a close fit on the seatpost.

8. A bicycle provided with a collar attachment in accordance with claim 7, in which a saddlebag is mounted on the bicycle, the saddlebag being connected to the seatpost by the collar attachment.

9. A bicycle as claimed in claim 8, in which the seatpost is a dropper seatpost.

10. A bicycle as claimed in claim 9, in which the seatpost is axially displaceable through a dropper seatpost collar fitted to the top of a seat tube of the bicycle, the diameter of the second internal bore being sufficiently large to accommodate the dropper seatpost collar.

11. A bicycle as claimed in claim 10, in which the seatpost is in a lowered condition, and in which the second internal bore accommodates the dropper seatpost collar through which the seatpost extends.
